(19) United States
(12) Patent Application Publication
(10) Pub. No.: US 2009/0236296 A1
(43) Pub. Date: Sep. 24, 2009

(54) Centrifuge Device For the Prevention of Cross-Contamination

(76) Inventor: Joachim Schmid, Wallhausen (DE)

Correspondence Address: SHLESINGER, ARKWRIGHT & GARVEY LLP, 1420 KING STREET, SUITE 600, ALEXANDRIA, VA, 22314, US

(21) Appl. No.: 11/922,248

(22) PCT Filed: Jun. 9, 2006
(86) PCT No.: PCT/EP2006/005547

§ 371 Date: Dec. 14, 2007

(30) Foreign Application Priority Data
Jun. 15, 2005 (DE) 10 2005 028 825.1

(51) Int. Cl. B04B 3/02; B04B 3/00; B04B 11/04; B04B 7/08

(52) U.S. Cl. 210/770; 210/360.1; 210/377

(57) ABSTRACT

The invention relates to an improved centrifuge device for preventing cross-contamination. Said centrifuge device comprises a drive shaft that is provided with a rotational shaft, a drum which is connected to the rotational shaft and encompasses a drum bucket and a drum bottom, a filter which is located inside the drum and surrounds a work space, an annular space embodied between the filter and the drum jacket, a catchment disk located across from the drum bottom to close the work space, and a centrifuge housing surrounding the drum and the filter. Also disclosed are devices for preventing cross-contamination, especially injection devices for injecting a rinsing fluid, a sealing arrangement, and a vertical adjusting device. The invention further relates to a method for operating a centrifuge device.

The present invention relates to an improved centrifuge device for preventing cross-contamination and a method of operating a centrifuge device.

The term “centrifuge devices” in conjunction with the present invention refer to any embodiments of centrifuge devices. Within the scope of the present description reference is made in particular to centrifuge devices with an integrated dryer function, so-called centrifuged dryers. The present invention and the technical features disclosed therein may also be applied, however, to centrifuge devices without an integrated dryer and to all other kinds of centrifuges. The term centrifuge device is thus to be understood as not restricted to a particular type of centrifuge.

Centrifuge devices are known in a variety of applications in the field of industrial use. In the pharmaceutical industry, in particular, they play a major part in the manufacture of medicines. The known centrifuge devices share the common feature that in a suspension contained therein, i.e. a fluid with a solid component, the solid phase is to be separated from the liquid phase. In centrifuge devices with dryers the solid phase is additionally dried after the separation so as to produce a powder.

The separation of solid phase and liquid phase takes place by introducing the suspension into a drum through a filling means and this drum is then rotated at high speed. It is also known to set the drum rotating first and then add the fluid during rotation, in order to avoid an imbalance caused by the introduction of the suspension at the start of the rotation process. During the rotation, strong centrifugal forces act on the suspension, causing the suspension to be pressed against the outer surface of the drum, uniformly distributed around the circumference.

A filer is provided on the outer surface of the drum. This may be a filter cloth, as in an inverted centrifuge, for example, or it may be a metal filter element. The use of a filter element means that the liquid phase of the suspension passes through the filter during centrifuging while the solid phase remains inside the drum.

The drum traditionally consists of an outer surface and a drum base which is integrally formed with the outer surface and forms an end face of the drum. The drum base is mounted on a drive shaft which is in turn driven by a motor. A second end face of the drum is formed by a catchment disk which seals off the drum. The drum, i.e. the drum jacket and drum base, and the catchment disk are axially movable relative to one another so that the end product can be removed from the interior of the drum. The catchment disk is mounted on a catchment disk shaft. Generally, one of the shafts (i.e. the catchment disk shaft or drive shaft) is of hollow construction so as to form a channel through which the suspension can be introduced into the interior of the drum, even if the drum is already rotating.

Frequently, the filter is of conical construction, in which case an axial force also acts on the suspension during centrifuging, causing the centrifuged product to collect on one end face of the drum. The end face is usually the one formed by the catchment disk, as this end face is opened in order to take out the product. In addition, the conical shape of the filter assists the movement of production in the direction of the catchment disk during drying and removal of the product.

After centrifuging, the wet solid phase of the suspension adheres to the interior of the drum jacket in a specific layer thickness. This adhering suspension is referred as the cake. Various methods are known for removing this cake from the drum. They can generally be subdivided into pneumatic removal methods and mechanical removal methods.

The mechanical removal methods include on the one hand the method of a filter cloth consisting of an elastic filter material which is used in inverted centrifuges. This filter cloth has the shape of a cylinder jacket and is connected at one edge to the drum jacket and at the other edge to a second drum base which, when the drum is closed, is arranged directly on the inside of the first drum base. The second drum base is moreover connected to the catchment disk so as to move together with it. The catchment disk and the second drum base are then moved axially relative to the drum, while the filter cloth is so to speak “turned inside out”. The catchment disk the second drum base have to be moved over twice the length of the drum until the entire filter cloth has been inverted. The inversion causes the cake to be detached from the filter cloth and the centrifuged product can be removed. A disadvantage of this design is that the catchment disk has to be moved twice the length of the drum and the entire centrifuge device therefore assumes substantial dimensions.

In another known mechanical method of removing the cake, a second drum base connected to the catchment disk is again used. However, instead of a filter cloth, a metal filter is used which is arranged on the inside of the drum jacket. The second drum base has a diameter which is only slightly smaller than the diameter of the metal filter. For removal, the catchment disk and the second drum base are then moved axially relative to the drum with the metal filter, so that the second drum base pushes the cake out of the drum. An advantage of this arrangement is that the axial length of the centrifuge device as a whole is shorter, as the catchment disk and the second drum base only have to be moved along the distance of one drum length. A disadvantage is that the gap between the second drum base and the metal filter may become so large, as a result of manufacturing inaccuracies or wear, that residues of product in the drum adhere to the filter and remain in the drum. Then even repeated movement of the second drum base has no chance of dislodging these residues or product and the filter remains clogged by these residues.

In pneumatic removal methods, a fluid, usually a gaseous fluid, is injected under high pressure into an intermediate space between the metal filter and the drum jacket, known as an annular chamber, and the cake is broken away from the filter in this way, to come to rest in the lower part of the drum. Owing to the fact that the filter has a cone which widens out to the catchment disk in this method, repeated surges of gaseous fluid may cause the product located on the base of the drum to be transported successively towards the catchment disk and transported out of the drum.

Moreover, each of the types of centrifuge devices mentioned above may also be equipped with a dryer function which allows the wet solid phase of the suspension to be dried after centrifuging. This is done, for example, in centrifuge devices with a pneumatic outlet by spraying a fluid into the interior of the drum so that the product contained in the drum gradually dries. Thus, after the drum has been opened, by movement of the catchment disk, a dried product can be removed in powder form and further processed immediately.

In the industrial use of centrifuge devices cases may arise in which different suspensions for producing different products have to be processed in successive production runs. In order that all the products can be produced to the same high quality, the centrifuge device has to be cleaned thoroughly before a new suspension is introduced. Only in this way can all interactions between successively processed products be avoided. These undesirable interactions are known as cross-contamination.

Since manual opening of the centrifuge device and manual cleaning are very time consuming, automatic cleaning processes are theoretically preferable, as they increase the economic viability of a centrifuge device. Moreover, only automatic cleaning processes permit a so-called high containment capability of the centrifuge device. By this is meant the possibility of processing toxic products without the need to provide special protective clothing for the operating personnel or other additional protective measures. In the case of toxic products, manual cleaning is impossible in most cases as the cleaning personnel would suffer damage to their health as a result.

In certain circumstances it may even be the case that first of all a toxic product has to be processed and in a subsequent production run a medicine is produced. In this case it is essential that the centrifuge device is cleansed of any toxic residues before the second product is processed.

The interaction of residues of a product remaining in the centrifuge device with a new suspension for processing is known as cross-contamination. Thus, a major objective is to provide a centrifuge device which totally prevents cross-contamination by flushing all product residues out of the centrifuge device.

The problem of cross-contamination is only inadequately solved by the prior art. The technical features explained hereinafter provide means which allow total cleaning of a centrifuge device so as to prevent cross-contamination. Thus it is possible to use a centrifuge device with variable suspensions or finished products and the economic viability of the centrifuge device is increased.

As already explained hereinbefore, the technical features are indeed explained in a preferred embodiment of a centrifuge device but are theoretically applicable to every other conceivable type of centrifuge and in particular to the known types of centrifuge mentioned earlier.

According to the invention a centrifuge device is provided, having: a drive shaft with a rotational shaft axis, a drum attached to the drive shaft having a drum jacket and a drum base, a filter arranged inside the drum and surrounding a working space, an annular space formed between the filter and drum jacket, a catchment disk forming an end face of the working space opposite the drum base, the catchment disk and the drum being movable relative to one another between a closed position in which the catchment disk seals off the working chamber and at least one open position, and a centrifuge housing which surrounds the drum and the filter.

In a preferred embodiment of the invention, adjoining the working space on the catchment disk side, is an annular channel having an annular channel housing that surrounds the annular channel. If the catchment disk is moved into an open position the finished product can be transported from the working space into the annular channel and from there passes out of the centrifuge device through a discharge opening. The discharge opening is preferably arranged in the lower part of the annular channel so that gravity causes the finished product to fall through the discharge opening.

To avoid confusion, it should be pointed out once again that a distinction must be drawn between the annular channel, which adjoins the working space as a region on the catchment disk side, and the annular space which is located between the filter and the drum jacket.

In a preferred embodiment of the invention, adjoining the annular channel opposite the working chamber is a catchment disk region with a catchment disk housing surrounding the catchment disk region. In the catchment disk region is found, for example, the majority of the catchment disk shaft and the bearings that interact with the catchment disk shaft.

In a preferred embodiment of the invention the filter widens out conically from the drum base to the catchment disk. Preferably, a metal filter made of a rigid material is used as the filter. The filter is preferably fixedly attached to the drum. Preferably, the filter thus remains in the drum during relative movement of the drum and catchment disk to one another.

In a preferred embodiment the centrifuge device comprises a lift adjusting device for pivotably adjusting the centrifuge device about a horizontal axis which is substantially perpendicular to the rotation axis of the drive shaft. Preferably, the lift adjusting device is a trapezium spindle. In a preferred embodiment the centrifuge device can be pivoted out of the horizontal position by at least 3° in both directions of rotation.

The use of a lift adjusting device according to the invention gives rise to numerous advantages. The biggest advantage is that by pivoting the centrifuge device the direction of flow of all the liquids contained in the centrifuge device can be controlled. In conventional centrifuge devices in which either the catchment disk shaft of the drive shaft is of hollow construction and is used as a filling tube for the introduction of the suspension, some suspension is left on the bottom of the tube after the filling process, for example. However, the filling tube is difficult to access over its entire length and hence difficult to clean. The lift adjusting device has the advantage that the centrifuge device can be tilted so that the suspension flows straight downwards during the filling process in the filling tube. At the end of the filling process any suspension still remaining in the filling tube flows out of the filling tube into the working space. Only when no more suspension is left in the filling tube is the centrifuge device tilted back into a horizontal position. The same advantages are obtained when emptying the liquid phase of the suspension after centrifuging.

Another advantage of the lift adjusting device is that the advantages of a conical filter can be enhanced. If the angle of opening of the filter cone is 5°, for example, this can be increased, as a result of the inclination obtained by the conicity, by tiling the entire centrifuge device through 3°, for example, to give a total of 8° C. This results for example in faster transportation of the centrifuged solid phase of the suspension towards the catchment disk. Moreover, a conical filter is no longer absolutely necessary per se as the desired inclination of the filter can be achieved solely by tilting the apparatus as a whole. Theoretically, a cylindrical filter is also possible. The necessary inclination would then be achieved solely by tiling the centrifuge device as a whole using the lift adjusting device. An operating method for a centrifuge device with a lift adjusting device will be described in more detail hereinafter.

In a preferred embodiment of the invention at least two axial webs supporting the filter are arranged in the annular space, these webs subdividing the annular space into at least two chambers, and for each of the chambers a drum base opening is provided in the drum base.

In a preferred embodiment of the invention an ultrasound cleaning device is provided inside the centrifuge housing, arranged such that it can be inserted through one of the openings in the drum base into the annular space in order to clean the chamber associated with the drum base opening. By rotating the drum further and guiding the ultrasound cleaning device into all the chambers in succession, the chambers can thus be successively cleaned.

One of the worst problem sites in cross-contamination in centrifuge devices is the filter itself. In order to detach all residues from the filter pores, the invention proposes the use of an ultrasound cleaning device. As the efficiency of an ultrasound cleaning device decreases as the distance between the object to be cleaned and the ultrasound cleaning device increases, the ultrasound cleaning device should be placed as close possible to the object which is to be cleaned. Consequently, an ultrasound cleaning device is preferably introduced into the annular space between the drum and filter during a cleaning operation for effective cleaning of the filter.

It may be sufficient to provide an ultrasound cleaning device which after the cleaning of a chamber is removed from it once more, whereupon the drum is rotated through a certain angle so that the ultrasound cleaning device can be inserted through another opening in the drum base into another chamber. Thus the chambers can be cleaned one after another. Obviously, a plurality of ultrasound cleaning devices may also be provided to allow several chambers to be cleaned simultaneously.

In one embodiment of the invention the catchment disk is mounted on a hollow catchment disk shaft which forms a PAT (process analysis technology) channel per se, a tube being guided through the PAT channel, projecting into the working space and an ultrasound cleaning device being provided at the end thereof which is in the working space. In this way an ultrasound cleaning device is passed through the hollow catchment disk shaft into the working space. Obviously, the drive shaft or another fill element is then used to introduce the suspension into the working space. If the catchment disk shaft is to be used for introducing a suspension into the working space, the ultrasound cleaning device can be inserted in the working space through a tube passing through a hollow drive shaft. The tube to which the ultrasound cleaning device is attached may also be designed to be rotatable, so that the ultrasound cleaning device can be moved in the working space in order to bring it close to an area that is to be cleaned.

In a preferred embodiment of the invention the catchment disk has an encircling collar which is arranged so that in an opened position of the catchment disk the collar together with a catchment disk housing element seals off the catchment disk region from the annular channel. In the opened position a product is therefore only able to be in the working space or in the annular channel. This minimises the area that has to be cleaned, as the product cannot spread into the other parts of the centrifuge device. When the catchment disk is opened, it is moved axially at high speed over a first distance until the edge meets the catchment disk housing element to seal off the annular channel, then the axial speed of movement is reduced. In this way a sealed fit of the catchment disk inside the catchment disk housing is achieved before the dried solid phase contained in the working space, i.e. the product, is released and spreads through the annular channel. In this way it is possible to at least minimise the entry of product into the catchment disk region. As a precaution, means for cleaning the catchment disk region may additionally be provided in the catchment disk region.

It would also be possible to have an embodiment in which the collar extends away from the catchment disk, even in the closed state of the catchment disk, to an extent where it forms a sealing engagement with the catchment disk housing element. This would ensure a sealing closure of the annular channel relative to the catchment disk region on the catchment disk.

In one embodiment of the invention, at least one follower pin is embedded in a drum, projecting axially into the annular space. In a preferred embodiment of the invention at least one follower pin is embedded in a pin holding element fixedly attached to the drum, said follower pin projecting axially into the annular space.

In a preferred embodiment of the invention, in a housing region that separates the annular channel and the catchment disk region, at least one pin is embedded which is arranged so that it is opposite at least one follower pin.

Preferably, there is at least one recess in the catchment disk which engages with the at least one follower pin or with the at least one pin.

The follower pins achieve the following advantage over the prior art. In contrast to the conventional two positions of a catchment disk, a closed position and an open position, there is now a third advantageous positioning option for the catchment disk.

In the closed position the catchment disk with its recess engages with the follower pin, so that the catchment disk rotates with the drum and seals it off. In the open position the catchment disk with the recess engages with the pin and is uncoupled from the rotation of the drum. In a new third intermediate position made possible by the technical features of the invention, the catchment disk is an open position but engages with its recess with the follower pin. Thus, the catchment is located in an open intermediate position in which a connection between the annular channel and working space is formed and the catchment disk still rotates with the drum.

In a cleaning process it is now possible to rotate the catchment disk with the drum in an opened position while a flushing fluid is sprayed into the annular channel and into the interior of the centrifuge housing. Because of the open catchment disk the working space and annular channel are no longer separate from one another. Consequently on the one hand the cleaning devices of the annular channel at least partly clean the working area and on the other hand the cleaning devices of the working space partly also clean the annular channel. By the rotation of the catchment disk during the cleaning process and by the fact that the catchment disk is accessible from all sides in the open position, the catchment disk can be cleaned particularly thoroughly by means of the cleaning devices. The seals and sealing surfaces between the working space and annular channel can also be cleaned.

In a preferred embodiment of the invention, at least one injection device is arranged in the centrifuge housing in such a way that it sprays a flushing fluid into an intermediate space between the centrifuge housing and drum. Preferably, three injection devices are provided in the centrifuge device, arranged at 120° intervals around the circumference of the centrifuge housing.

In a preferred embodiment of the invention at least one injection device is arranged in the annular channel housing in such a way as to flush a flushing fluid into the annular channel. Preferably, three injection devices are provided which are arranged at 120° intervals around the circumference of the annular channel housing.

In a preferred embodiment of the invention, at least one injection device is arranged in the catchment disk housing in such a way as to spray a flushing fluid into the interior of the catchment disk housing. Preferably, three injection devices are provided which are arranged at 120° intervals around the circumference of the catchment disk housing.

In a preferred embodiment of the invention, three injection devices are provided in the centrifuge housing which are arranged at 120° intervals around the circumference of the centrifuge housing and spray a flushing fluid into the intermediate space between the centrifuge housing and drum. Furthermore, three injection devices are provided in the annular channel housing, arranged at 120° intervals around the circumference of the annular channel housing and spray a flushing fluid into the annular channel and in the catchment disk housing there are three injection devices which are arranged at 120° intervals around the circumference of the catchment disk housing and spray a flushing fluid into the interior of the catchment disk housing.

Thanks to the arrangement of injection devices in the catchment disk region, in the annular channel and in the centrifuge housing, as described above, these areas can be cleaned completely. The injection devices may be constructed in any suitable conceivable form. For example, spray heads or nozzles are possible. The use of a plurality of nozzles in an offset arrangement ensures particularly good cleaning over the entire circumference of the areas in question. Particularly in conjunction with the other features of the invention, e.g. with the possible third position of the catchment disk in which it rotates in an open state, a high cleaning efficiency is achieved. Thus, the catchment disk can be rotated and is cleaned by the three injection devices arranged in the annular channel similar to a washing plant. The injection devices in the annular channel also spray into the working space. The injection devices that spray into the working space also spray into the annular channel and onto the catchment disk.

In a preferred embodiment of the invention, an, in particular axially movable, nozzle is arranged opposite at least one of the openings in the drum base so that it injects a fluid through the respective opening in the drum base into the corresponding chamber of the annular space. The fluid used may correspond to the flushing fluid.

Preferably, at a tip of the at least one nozzle, there is mounted a plate element with a flange for sealing off the at least one nozzle at the drum base. In one embodiment of the invention the at least one nozzle and the respective plate element are integrally formed.

In a preferred embodiment of the invention a bellows is arranged between the plate element and the centrifuge housing, this bellows surrounding a section of the at least one nozzle located inside the centrifuge housing.

Preferably the centrifuge device encompasses a device for causing axial movement of the at least one nozzle. Preferably the device for effecting axial movement of the at least one nozzle is a reciprocating piston arrangement. In one embodiment of the invention the device for causing axial movement of the at least one nozzle is a pneumatic device. Preferably, the nozzle is a Laval nozzle.

In a preferred embodiment a valve is provided in such a way that a fluid flows through the at least one valve before entering the at least one nozzle. Preferably, the valve is a cone membrane valve. Preferably, separate inlets for a plurality of fluids are provided for the at least one valve.

Thanks to the features described above it is possible to inject a fluid or a flushing fluid into the chamber of the annular space. This makes it possible on the one hand to break off the suspension cake adhering to the filter after centrifuging and moreover the filter and the chamber can be cleaned using a flushing fluid. The possibility of moving the nozzle axially means that when the drum is stationary the nozzle with its flange can be moved up directly to the openings in the drum base, as a result of which fluid can be injected into the annular space under particularly high pressure. Moreover, only a very little flushing fluid is wasted as there is no longer a gap between the nozzle and drum base through which the flushing fluid can escape. As a result, the economic viability of the centrifuge device is increased.

Cleaning of the filter by injecting a flushing fluid into the chamber is particularly effective as the flushing fluid is forced through the pores of the filter into the working space and suspension residues in the filter are flushed out. As the direction of flow of the flushing fluid runs counter to the direction in which the suspension was forced into the filter, highly effective cleaning is achieved. By the use of Laval nozzles it is possible to achieve fluid velocities in excess of Mach 1. Thanks to the resulting high velocity a high impulse is obtained which is particularly advantageous for breaking off the suspension cake as this is broken off over the entire surface of the filter. Problems of conventional centrifuge devices in which the filter cake is broken off only in part thus do not arise. Partial breaking off of the filter cake leads to problems in that the breaking off of the remaining filter cake is generally unsuccessful because the fluid subjected to pressure escapes through the free filter pores without having any effect on the adhering cake residues. Thus, the breaking off of the suspension cake should succeed at the first attempt, and this is made possible by the option of mounting the nozzles directly on the drum base in order to inject a fluid into the annular space chambers without any losses between the nozzle and the opening in the drum base and to make full use of the energy of the fluid.

Various methods of injecting the fluid into the annular space chambers are explained hereinafter. Basically, the nozzles can be brought up to the drum, leaving a small gap, and while the drum rotates continuously a fluid can be injected into the annular space chambers when the openings in the drum base are located in front of the nozzles in question. Another method of injecting liquid into the annular space chambers is to place the nozzles on the drum base, inject a fluid into the corresponding annular space chambers, move the nozzles back, rotate the drum through a certain angle such that the next openings in the drum base are located in front of the nozzles, bring the nozzles close to the drum base again, spray more fluid into the next annular space chambers, etc.

The method described hereinbefore requires a high accuracy of positioning of the drum. The position of the drum must be capable of being regulated so precisely that the openings in the drum base are located opposite the nozzles. In order to compensate any minor inaccuracies in positioning, in one embodiment of the invention the openings in the drum base are in the form of oblong holes.

In order to meet the exacting requirements relating to the positioning accuracy of the drum, therefore according to one embodiment of the invention an asynchronous motor is used to drive the drive shaft, this motor being controlled by a control unit. Also included in the control circuit is a transmitter unit which is a sine/cosine transmitter. The asynchronous motor is thus capable of rotating in both directions of rotation. The asynchronous motor in this embodiment comprises a secondary shaft passing through it, which is connected in each case via force-transmitting endless elements, e.g. a toothed belt, to an endless element of the drive shaft and the shaft of the transmitter unit. The combination of features described above provides an electrical drive machine which can be controlled extremely accurately by a control process, and thus gives the necessary positional accuracy of the drum.

Furthermore, the adjustment possibilities of the drive motor and system as a whole mentioned above result in high positional accuracy of the nozzles or nozzle valves. In addition to the positional accuracy of the drum, the adjustment accuracy is crucial to the injection of a fluid by the nozzle reaching the annular space chambers with the best possible efficiency, in order to ensure that the filter cake is broken away completely and the centrifuge device is effectively cleaned to prevent cross contamination.

In one embodiment of the invention a fluid used is air. In another embodiment of the invention a fluid used is nitrogen. In another embodiment of the invention a fluid used is steam. In another embodiment of the invention a fluid used is a suitable solvent for the suspension. Generally, for breaking off the suspension cake, a fluid should be used which does not react with the suspension. A particularly suitable fluid for the cleaning is a solvent for the suspension in question.

The use of a cone membrane valve with a plurality of inlets makes it possible on the one hand to inject or convey the fluid accurately to the nozzles and on the other hand it allows the use of several fluids in one operation. In some cases it may also be necessary to use different fluids for breaking off the filter cake and for cleaning the device. Under certain circumstances, fluid also has to be injected at other times, which is not the fluid for breaking off the filter cake or the fluid for cleaning the centrifuge device. Thus, any suitable number of inlets to the valves of the nozzles may be provided. Preferably, a cone membrane valve is used as it has particularly suitable properties, but any other type of valve is also possible. The features mentioned above also allow high accuracy of adjustment of the valves. This is a prerequisite for the breaking off of the filter cake to be carried out successfully, as this is the only way of ensuring total cleaning of the centrifuge device in order to prevent cross contamination.

In a preferred embodiment of the invention, at least one sliding ring seal gas-lubricated with a barrier gas is provided as the seal on at least one shaft of the centrifuge device; this sliding ring seal comprises a sealing surface arranged between a fixed sliding ring and a rotating sliding ring.

Preferably, the sealing surface of the gas-lubricated sliding ring seal extends radially outwards from the at least one shaft. In a preferred embodiment of the invention a housing portion is arranged such that it is disposed in front of the radially outer limit of the sealing surface of the gas-lubricated sliding ring seal, so that the housing portion defines a flushing gas gap between itself and the sliding ring seal. The housing portion may be a portion of the centrifuge housing, the annular channel housing, the catchment disk housing and/or another housing element of the centrifuge device.

In a preferred embodiment of the invention, inlets are provided in the centrifuge housing which carry a flushing fluid permanently into the interior of the centrifuge through the flushing gas gap. Preferably, the pressure acting upon the flushing fluid is less than the pressure acting upon the barrier gas of the sliding ring seal. Preferably, the pressure acting upon the flushing gas is approximately 3 bar and the pressure acting on the barrier gas is approximately 6 bar.

The sealing arrangement described above provides a particularly effective rotary seal of the centrifuge device. The additional housing element arranged in front of the sealing surface of the gas-lubricated sliding ring seal defines an additional flushing gas gap. In cross sectional view this flushing gas gap forms essentially a T-shape with the sealing surface. A flushing gas is permanently carried through this flushing gas gap by inlet lines which lead into a region of the centrifuge device partitioned off from the suspension or product. Because the pressure of the flushing gas is less than that of the barrier gas the flushing gas cannot enter the sliding ring seal but is directed into the interior of the centrifuge. This interior may be a catchment disk region, the annular channel, the working space or another space enclosed by a portion of a housing of the centrifuge device.

As a result of the fact that the flushing fluid flows permanently into the interior, the suspension of the product cannot enter the flushing gas gap counter to the flow density of the flushing gas. Obviously, the pressure of the flushing gas must always be higher than the pressure in the interior so that the flushing gas permanently flows into the space. This therefore provides a reliable sealing surface at the end of the flushing gas gap which is easily accessible. This produces a particularly easily cleanable surface geometry. Suspension or product is prevented from penetrating into the sliding ring seal and contaminating it. As the sliding ring seal in certain cases could then only be cleaned by dismantling the seal, the centrifuge device could not be operated during this period, which constitutes an economic disadvantage.

The reliable sealing of the sliding ring seals as described above results in a major advantage in the prevention of cross contamination, as even tiny amounts of toxic material which might be deposited in the sliding ring seals in conventional centrifuge devices can lead to the spoiling of a total production run of another product produced thereafter.

In a preferred embodiment of the invention the sliding ring seal according to the invention is provided on the drive shaft in order to seal the intermediate space between the centrifuge housing and the drum.

In a preferred embodiment of the invention the centrifuge device comprises an annular channel adjoining the catchment disk on the working space, with an annular channel housing surrounding the annular channel, and the sliding ring seal for sealing the annular channel is provided on a catchment disk shaft on which the catchment disk is mounted.

In a preferred embodiment of the invention the sliding ring seal is provided for sealing the catchment disk region of a catchment disk shaft. In a preferred embodiment of the invention the sliding ring seal is intended for sealing an insertion pin projecting into the fill channel on the corresponding shaft. Basically, the sealing arrangement described can be used with the additional housing element that forms a flushing gas gap and a flushing gas permanently passing through the flushing gas gap into the interior of the centrifuge device, in order to seal off all the regions or spaces from one another, on all the shaft used in the centrifuge device. It is also possible to use a sealing arrangement as described outside a centrifuge device.

A method of operating a centrifuge device, particularly a centrifuge device having the features of the main claim, which additionally comprises, on the catchment disk side, an annular channel adjoining the working space and having an annular channel housing surrounding the annular channel, comprises the following steps: introducing a suspension into the drum, centrifuging a suspension, first cleaning of the annular channel and interior of the centrifuge housing, drying the suspension, removing the dried product, carrying out a second cleaning of the annular channel and the interior of the centrifuge housing and the centrifuge device as a whole.

In the conventional method of operating a centrifuge device the entire centrifuge device is only cleaned after the dry product has been removed. However, by then, large residues of the suspension or product have already dried hard, making it difficult to remove them. Theoretically it is easier to rinse out a suspension or a moist product while it is still damp. For this reason the annular channel and the interior of the centrifuge housing are cleaned directly after centrifuging. The moist residues can thus be removed particularly satisfactorily. After the dry product has been removed the complete centrifuge device is then cleaned.

Preferably, the centrifuge device in the preferred method of operating a centrifuge device comprises three injection devices provided in the centrifuge device, arranged at 120° intervals from one another around the circumference of the centrifuge housing and they spray a flushing fluid into the intermediate space between the centrifuge housing and the drums, as well as a further three injection devices provided in the annular channel, arranged at 120° intervals around the circumference of the annular channel housing, which spray a flushing fluid into the annular channel, and furthermore three injection devices in the catchment disk housing which are arranged at 120° intervals around the circumference of the catchment disk housing, which spray a flushing fluid into the interior of the catchment disk housing. Moreover, the centrifuge device in this preferred method comprises at least one nozzle which is, in particular, axially movable relative to at least one of the openings in the drum base, this nozzle being arranged so as to spray a fluid through the respective opening in the drum base into the corresponding chamber of the annular space. Moreover, in the centrifuge device in the preferred method of operating a centrifuge device, the sealing arrangements described hereinbefore for sealing two regions of the centrifuge device are provided on a corresponding shaft, the sealing arrangements having inlets which carry a flushing fluid permanently through the flushing gas gap, directed into the interior of the centrifuge. In the preferred method of operating a centrifuge device the cleaning steps are carried out by injecting a suitable flushing fluid through the nozzles, the injection devices and the inlets.

The simultaneous spraying by means of the devices described above achieves a particularly good cleaning effect. Particularly the annular channel and working space through which the product passes are sprayed with flushing fluid by a number of devices. The centrifuge device is cleaned completely, in the manner of a washing plant. These cleaning possibilities result in an improvement over the prior art. In a preferred method of operating a centrifuge device, the centrifuge device also comprises follower pins and pins in the annular channel according to the invention and the catchment disk is moved during the cleaning operations into a third position in which the catchment disk engages through a recess with a follower pin fixedly connected to the drum and rotates together with the drum.

As already described, cleaning devices can thus be used in supplementary fashion in the working space and in the annular channel, the catchment disk is accessible from all sides and is sprayed as it rotates. The combination with the other features of the invention thus produces an improved cleaning effect. In one embodiment of the method according to the invention for operating a centrifuge device, the centrifuge device comprises nozzles according to the invention comprising plate flanges, the nozzles being arranged opposite the openings in the drum base and axially movable. During the cleaning steps the drum rotates continuously and the flanges of the plates of the nozzles are moved up to the drum base but do not make contact with it. When an opening in the drum base is located opposite the at least one nozzle, a flushing fluid is pulse-sprayed into each opening in the drum base. In this way it is possible to clean the rotating drum.

In another method of operating a centrifuge device with the features described above, the drum rotates continuously during the cleaning steps and the flanges on the plates of the nozzles are moved up to the drum base but do not touch it and, when an opening in the drum base is located opposite the at least one nozzle, a flushing fluid is injected into the opening in the drum base, while between the individual pulses of flushing fluid, at least one opening in the drum base passes the at least one nozzle without a pulse of flushing fluid being injected. In this embodiment of the process the drum can rotate at a higher speed as fluid is not injected into every opening in the drum base. This may be necessary in certain cases when the setting times of the valves are not small enough.

In another embodiment of the invention for operating a centrifuge device having the features described hereinbefore, during the cleaning steps the injection of flushing fluid into the annular chambers is carried out in pulses and the drum is rotated through a certain angle between the pulses, such that during the pulses the drum is rotated into a position such that the at least one nozzle is arranged opposite the corresponding opening in the drum base and the flanges abut on the drum base. As already described previously, it is thus possible to inject fluid into the annular chambers under particularly high pressure and no flushing fluid is wasted. However, cleaning takes places successively, without rotation of the drum. Obviously, a cleaning step may also be carried out by first using an embodiment of the cleaning process in which the drum rotates continuously and then using the embodiments described above in which the drum is cleaned successively.

Any other desired combinations of the methods or any other desired sequences are obviously also possible.

In another embodiment of the process for operating a centrifuge device, the centrifuge device according to the invention comprises the lift adjusting device according to the invention by means of which the centrifuge can be pivoted out by at least 3° to a horizontal position in both directions of rotation. In this embodiment of the process the centrifuge device is tilted by an angle α from the horizontal by means of the lift adjusting device before the filling step so that the centre point of the drum base is located above the centre point of the catchment disk. As already described hereinbefore, this thus achieves the effect, with the centrifuge device according to the invention, that any fluid remaining in the fill channel at the end of the filling process runs into the working space. If another shaft were used for the filling, the centrifuge device would have to be tilted differently accordingly. If for example the catchment disk shaft were used to introduce a fluid, the centrifuge device would therefore have to be tilted so that the centre of the catchment disk is located above the centre of the drum base. Corresponding reversals in the direction of tilt dependent on the embodiment of the centrifuge device used also apply to the tilting operations described below. The tilting operations are each carried out only for the preferred embodiment of a centrifuge device described.

In another method of operating a centrifuge device, the centrifuge device is tilted by an angle β to the horizontal, between the first cleaning step and the drying step, by means of the lift adjusting device, such that the centre of the catchment disk is located above the centre of the drum base and then, before the drying step, it is tilted by an angle α to the horizontal once more so that the centre of the drum base is located above the centre of the catchment disk. As already described previously, the centrifuge device is tilted so that after centrifuging the liquid phase of the suspension emerging from the filter flows away better. Then the centrifuge device is tilted back in order to assist the movement of the product towards the catchment disk during drying. Thus it is also possible to use a centrifuge device with a cylindrical filter which does not have a cone. In a filter with a cone the centrifuge device is correspondingly tilted so that the effect of the cone is intensified.

In another embodiment of the process for operating a centrifuge device, the centrifuge device is tilted by an angle β to the horizontal by means of the lift adjusting device, after the second cleaning step, such that the centre of the catchment disk is located above the centre of the drum base. This in turn is done in order to assist the outflow of liquid during cleaning.

In another embodiment of the process for operating a centrifuge device both angle α and angle β are about 3°.

Thanks to the possibility of tilting the entire centrifuge device, an improved cleaning efficiency is obtained compared with the prior art, together with the other technical features of the centrifuge device. The method described above ensures an effective combination of the individual technical features and ensures an improved cleaning effect. The total cleaning of the centrifuge device prevents cross-contamination and the centrifuge device can be operated immediately with a second suspension that is different from a first suspension. Even when toxic suspensions are used high flexibility is guaranteed and the economic viability is substantially improved.

Further features and embodiments of the invention will become apparent from the description and the accompanying drawings.

It will be appreciated that the features described above and those to be explained hereinafter may be used not only in the particular combination mentioned but also in other combinations or on their own without departing from the scope of the present invention.

The invention is schematically shown in the drawing by means of an exemplifying embodiment and is described in detail hereinafter with reference to the drawings.

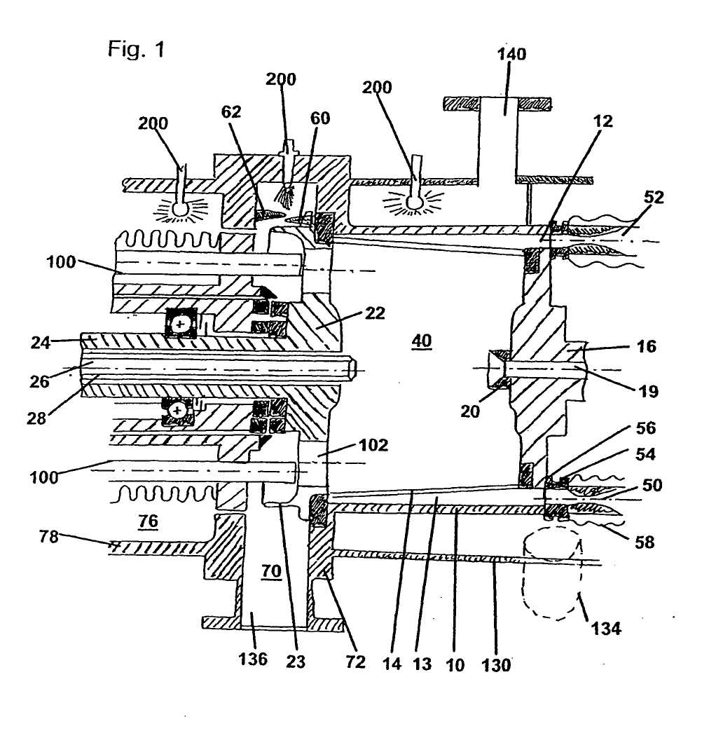

FIG. 1 shows a lateral cross-sectional view of the centrifuge device according to the invention, particularly the working space with the attached components, particularly the devices for preventing cross-contamination according to a preferred embodiment of the invention.

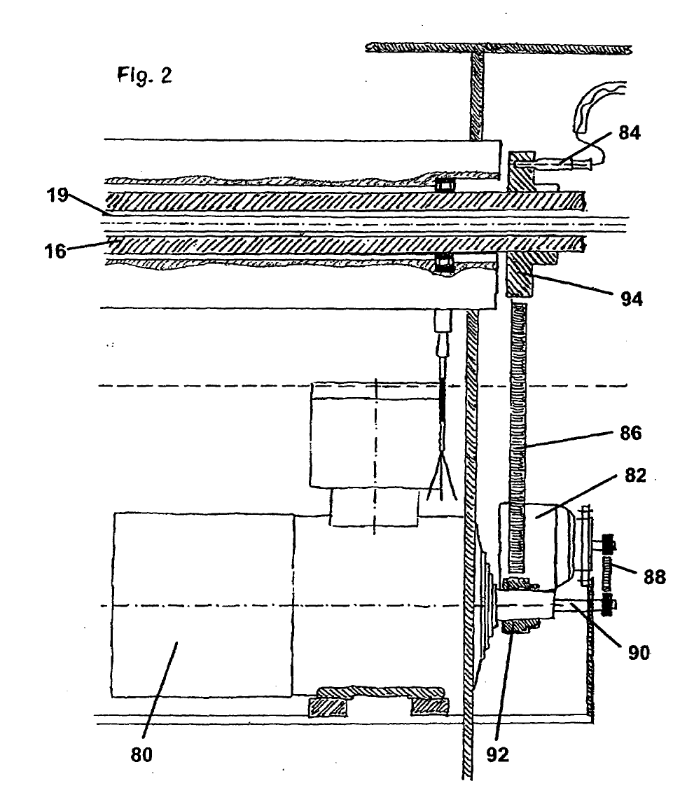

FIG. 2 shows a lateral cross-sectional view of the arrangement of an asynchronous motor in a preferred embodiment of the invention.

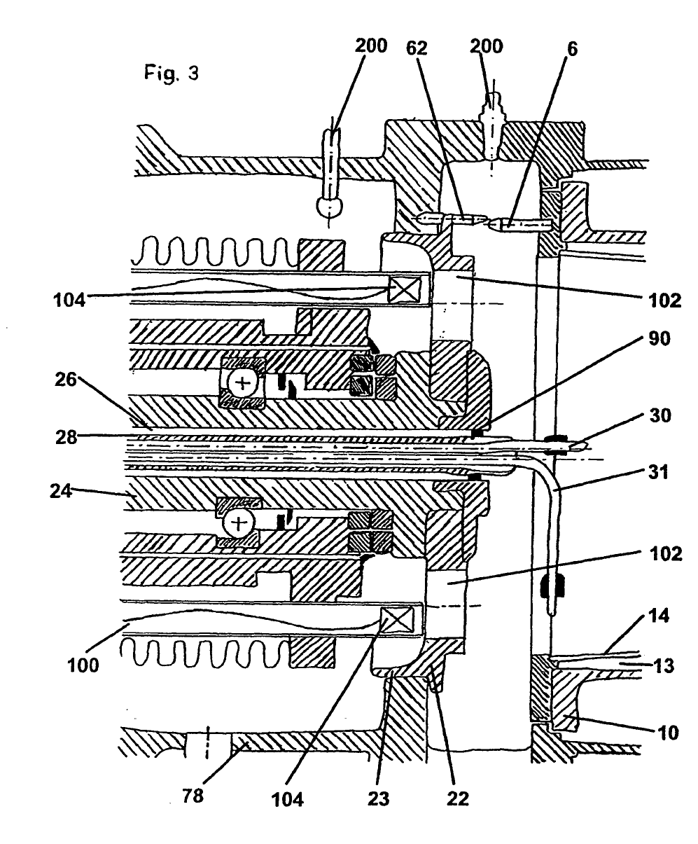

FIG. 3 shows an enlarged lateral cross-sectional view of the region of the catchment disk with tubes guided through a PAT channel and devices for process analysis inserted in the window channels.

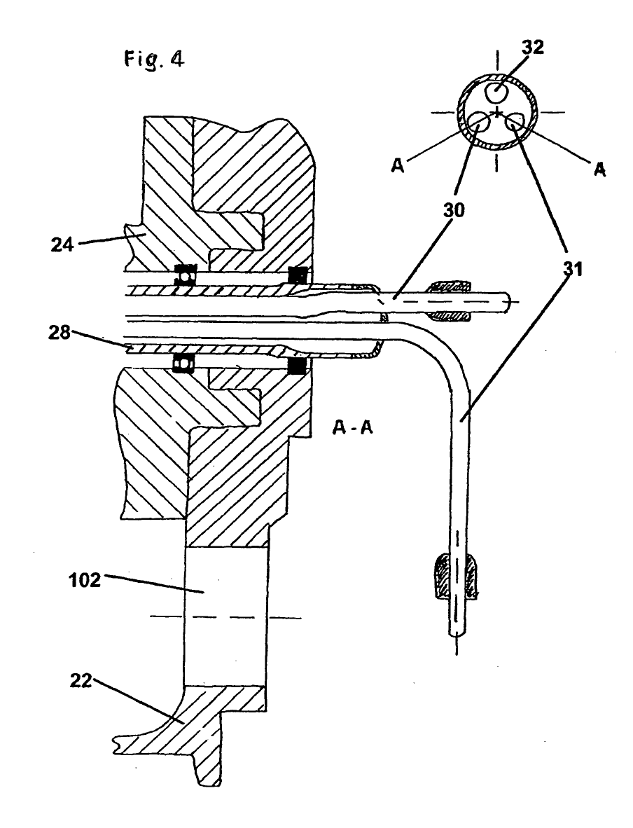

FIG. 4 shows an enlarged lateral cross-sectional view of the end of the PAT channel nearest the working space, in a preferred embodiment of the invention.

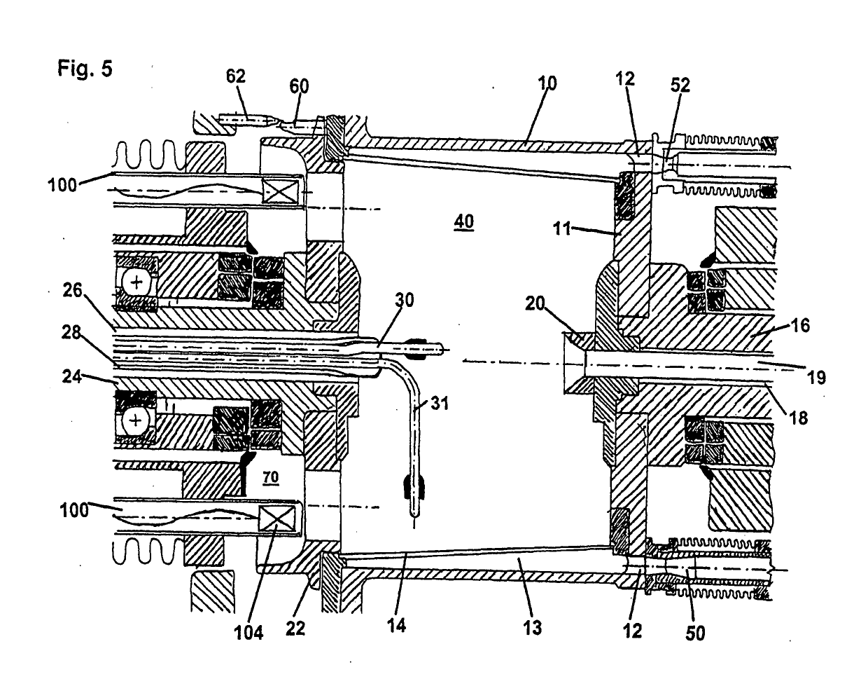

FIG. 5 shows a lateral cross-sectional view of the working space with the adjoining components in a preferred embodiment of the invention.

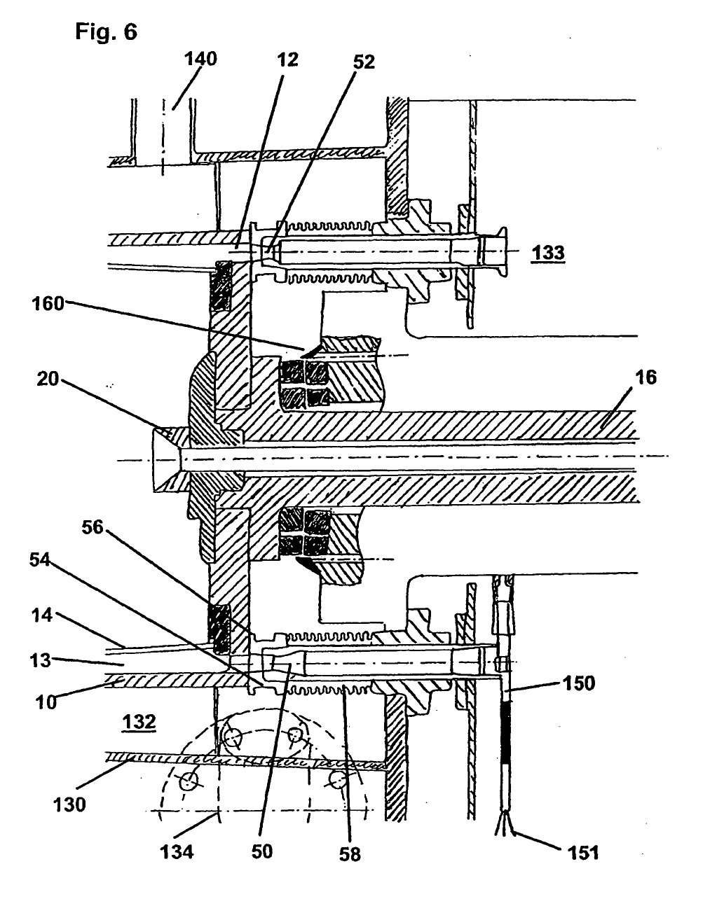

FIG. 6 shows an enlarged lateral cross-sectional view of the surroundings of the drum base, particularly the means for preventing cross-contamination according to a preferred embodiment of the invention.

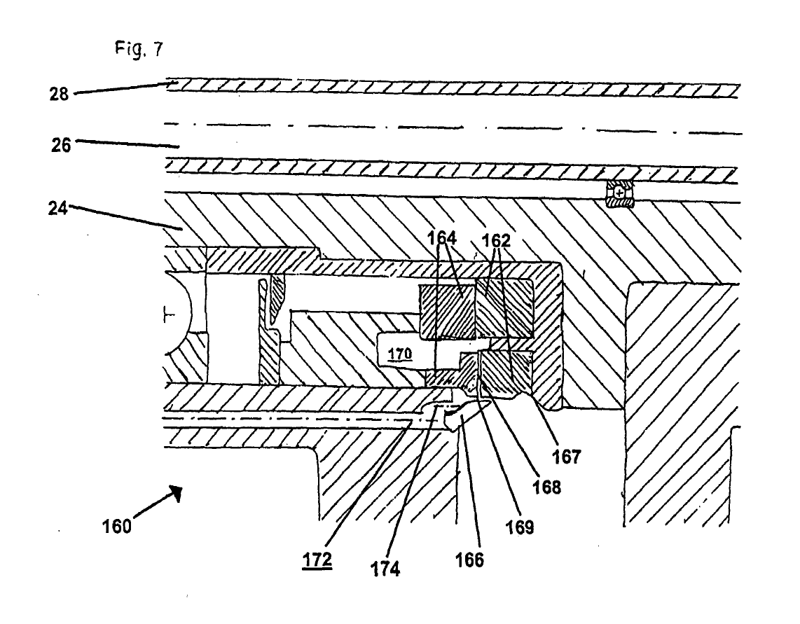

FIG. 7 shows a detail, in lateral cross-section, of a sealing device according to the invention for sealing a shaft of the centrifuge device.

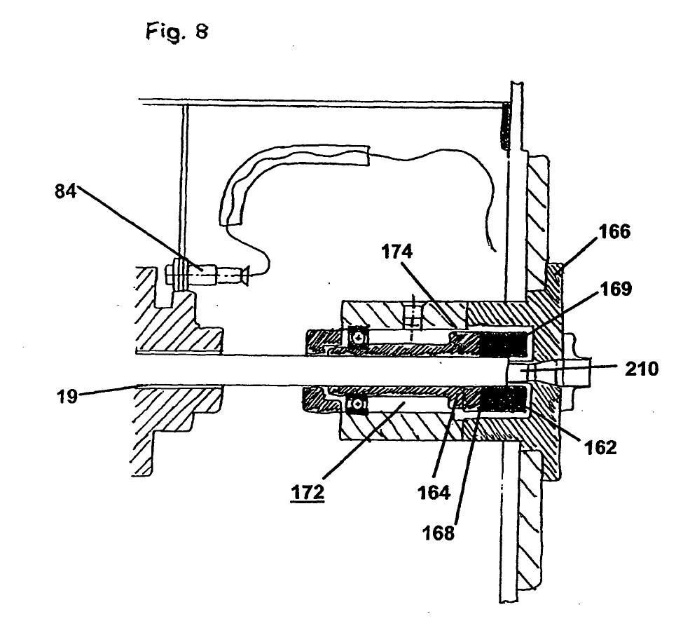

FIG. 8 shows a sealing arrangement according to the invention which is used to form a seal between a filling tap 210 and the fill tube 19.

FIG. 1 is a lateral cross-sectional view of the centrifuge device showing the working space 40 with the components surrounding it. The working space 40 is enclosed by a filter 14 consisting of a solid metallic material. The filter 14 is attached to a drum 10 which has openings 12 in its drum base. The drum 10 is mounted on a drive shaft 16 of hollow construction through which a drive shaft fill tube 19 is passed. Opposite the base of the drum 10 a catchment disk 22 seals off the working space 40. The catchment disk 22 is mounted on a catchment disk shaft 24 which is of hollow construction and through which a casing tube 28 is passed. Through the casing tube 28, which is also of hollow construction and comprises a PAT channel 26 inside it, devices for monitoring and measuring the conditions in the working space 40 can be inserted through tubes 30, 31, 32. Such devices include temperature measuring devices, means for near infrared (NIR) spectroscopy, cameras, light sources and devices for taking a sample of suspension out of the working space 40. Also formed in the catchment disk 22 are windows 102 of a transparent material. Leading to the windows are window channels 100 through which monitoring devices or measuring devices 104 can be moved up to the windows. Such devices include for example cameras, light sources or devices 104 for near infrared (NIR) spectroscopy.

The drum 10 is surrounded by a centrifuge housing 130 so that an intermediate space 132 is formed between the drum 10 and centrifuge housing 130. Adjoining the working space 40 on the catchment disk side is an annular channel 70 surrounded by an annular channel housing 72. Opposite the working space 40 a catchment disk region 76 adjoins the annular channel 70, this catchment disk region 76 being surrounded by a catchment disk housing 78. In the lower part of the annular channel 70 is a removal opening 136 through which a finished product is removed. Adjoining the intermediate space is an outflow 134 through which the liquid phase of the suspension can flow away out of the intermediate space 132. Also adjoining the intermediate space 132 is a fluid outlet 140 through which fluid, particularly gaseous fluid, can escape.

In front of the openings 12 in the drum base are nozzles 50, 52 which are axially movable. Preferably the axial movement is provided by a reciprocating piston device (not shown) . Plates 54 with flanges 56 are formed at a tip of the nozzles 50, 52. The flanges 56 can be moved axially close to the drum 10 so that the nozzles 50, 52 are situated directly in front of the openings 12 in the drum base, in the position shown in FIG. 1. Thus, by means of the nozzles 50, 52, fluid can be injected into an annular space 13 located between the drum 10 and the filter 14. The annular space 13 is divided into a plurality of annular space chambers by axially extending webs (not shown). Each annular space chamber is associated with an opening 12 in the drum base. There may be any number of annular space chambers, the number being selected according to the size of the drum. Similarly, the number of nozzles may vary and is not restricted to the number described in a preferred embodiment. A separate nozzle may be provided for each opening in the drum base, or there may be only one nozzle in all, in which case each opening in the drum base is rotated individually past this nozzle. The embodiment can be selected in accordance with the size of the centrifuge.

The nozzles 50, 52 are used on the one hand to inject fluid into the annular space 13 with a big pulse, so as to break off any suspension cake adhering to the filter 14, and on the other hand they are used to inject a fluid into the annular space 13 after the removal of the cake, in order to dry the suspension.

Projecting into the annular channel 70 is a follower pin 60 which is fixedly connected to the drum 10, and a pin 62 which is fixedly connected to the catchment disk housing 78. A recess is provided in the catchment disk 22, by means of which the catchment disk engages with the follower pin 60 in the closed arrangement shown. Alternatively, the catchment disk may be moved into a half-open position in which it still engages with the follower pin 60, so that when the working space is opened the catchment disk 22 rotates with the drum 10. In a third position the catchment disk is fully open and engages with its recess with the pin 62. In this position the catchment disk does not rotate. The half open position is preferably chosen during the cleaning of the centrifuge device. The fully open position is preferably chosen during the removal of the product. The catchment disk assumes the first closed position while the product is being introduced, during centrifuging and drying.

Injection devices 200 are provided in the centrifuge housing, in the annular channel housing and in the catchment disk housing, which inject a flushing fluid into the intermediate space 132, into the annular channel 70 and into the catchment disk region 76, respectively. The injection devices may for example take the form of spray heads or nozzles. However, any other suitable embodiment of injection device is also possible. In the preferred embodiment, three injection devices are arranged, at 120° intervals around the circumference of the corresponding housing, in the centrifuge housing, in the annular channel housing and in the catchment disk housing.

For sealing the catchment disk region 76 relative to the annular channel 70 at the catchment disk shaft 24, a sealing arrangement 160 is provided according to the invention, which is shown on a larger scale in FIG. 7. The sealing arrangement is described in more detail hereinafter.

In order to position the drum 10 with its openings 12 in the base during the injection of fluid by means of the nozzles 50, 52 in such a way that one opening 12 is located in front of each nozzle 50, 52, it is essential to have a highly accurate positioning of the drum 10. The openings in the drum base are admittedly preferably in the form of oblong holes to allow a degree of tolerance in the positioning of the drum 10, but the positioning of the drum 10 must nevertheless be very precise. To ensure this, in a preferred embodiment a drive arrangement as shown in FIG. 2 is provided. For driving the draft shaft, an electric asynchronous motor 80 is provided which can rotate a secondary shaft 90 mounted therein in both directions of rotation. The electric asynchronous motor is controlled by a control unit (not shown). In order to carry out highly accurate control of the position, the control unit (not shown) receives data as to the position of the shafts from a transmitter unit 82 which is a sine/cosine transmitter. Both the drive shaft 16 and the sine/cosine transmitter are connected to the secondary shaft 90 via a force-transmitting endless element 86, 88, preferably a toothed belt. To ensure a uniform zero position when switching on the centrifuge device, starting from which the control unit regulates the position control of the drum and the drive of the drive shaft, a zero position indicator 84 is provided which co-operates with a counter element (not shown) in the gear wheel 94. In a specific position the counter element is located opposite the zero position indicator 84, which is detected by the zero position indicator 84, so that the control unit recognises that a zero position has been assumed.

FIG. 3 shows an enlarged lateral cross-sectional view of the catchment disk 22 and the components that surround the catchment disk 22, the catchment disk being in a fully open position. In the fully open position the catchment disk 22 engages the recess provided therein with the second pin 62. In this position the catchment disk 22 is uncoupled from the rotation of the drum 10. FIG. 3 also shows the tubes 30, 31 passing into the PAT channel 26. Preferably there are three tubes 30, 31, 32 in a casing tube 28 which is guided in the PAT channel 26. The PAT channel 26 is sealed off from the working space 40 or annular channel 70 by a seal 90, the sealing element 90 preferably being an antiseptic double seal. In addition, FIG. 3 shows optical monitoring elements 104 which are arranged in the window channel 100 behind the windows 102 provided in the catchment disk 22.

The figure also shows how in the open position the collar 23 of the catchment disk 22 together with the catchment disk housing 78 seals off the catchment disk region 76 from the annular channel 70 on the housing.

FIG. 4 shows an enlarged lateral cross-sectional view of the tubes 30, 31, 32 projecting into the working space 40. The arrangement of the tubes 30, 31, 32 in the cross-section of the casing tube is also shown.

FIG. 5 shows a lateral cross-sectional view of the working space 40 with the components surrounding it in a preferred embodiment of the invention. In this preferred embodiment a funnel-shaped element 20 is also mounted on the fill tube 19, allowing the suspension to be introduced into the working space 40 without any suspension dripping down onto the base 11 of the drum. Experience has shown that suspension located on the base 11 of the drum and possibly also dried hard is difficult to rinse away from the base 11 of the drum. Thus, using the funnel-shaped element 20 ensures easier cleaning of the working space 40. Moreover, FIG. 5 also shows the tubes 30, 31 and the casing tube 28 that surrounds them, the tubes projecting into the working space 40 in a preferred embodiment. Preferably, a camera and a light source are mounted on one of the tubes, while on a second tube is mounted a device for measuring the temperature at the end of the tube closest to the working space and on a third tube is mounted a device for taking a sample of suspension from the working space. Using the light source the working space can be illuminated and monitored by means of the camera in the tube or the optical monitoring devices 104. In this way it is possible to tell whether there is still any contamination in the working space without having to dismantle the centrifuge device. In one embodiment, an ultrasound cleaning device may be mounted on one of the tubes at the end closest to the working space, by means of which the working space is cleaned. However, preferably an ultrasound cleaning device is arranged in a similar position to the nozzles 50, 52 (not shown) which can be moved axially into an annular space chamber 13 through an opening 12 in the base of the drum, in order to effectively clean the annular space chamber and the filter 14.

FIG. 6 shows the surroundings of the end face of the working space 40 at the drive shaft end, with the components arranged there. In particular, the nozzles 50, 52 are shown with their plates 54 arranged at the tips, the flanges 56 on the plates 54 and the bellows 58. The drawing also shows how the valves 150 and inlets 151 to the valves are arranged. A sealing arrangement 160 according to the invention is also used to seal off the intermediate space 132 from a region 133 of the centrifuge device on the drive shaft.

FIG. 7 is an enlarged view of the sealing arrangement 160 according to the invention. A sealing surface 168 is formed between a rotating sealing ring 162 and a stationary sealing ring 164. In a barrier gas space 170 there is a barrier gas which is preferably acted upon by a pressure of 6 bar. Moreover, a housing element 166 is arranged so that it is positioned transversely in front of the sealing surface 168 and thus forms a flushing gas gap 169. The flushing gas gap 169 and the sealing surface 168 form a T-shape in cross-sectional view. In a flushing gas space 172 there are inlets 174 through which a flushing gas is permanently conveyed into the flushing gas gap 169. Preferably, the flushing gas is acted upon by a pressure of 3 bar.

The flushing gas thus moves permanently from the flushing gas space 172 through the flushing gas gap 169 into the catchment disk region 70, in this instance. Instead of the catchment disk region 70 the flushing gas may also open into any other region. As the pressure of the compression gas is greater than the pressure of the flushing gas, the flushing gas cannot escape into the sealing surface 168. A product or a suspension located in the catchment disk region 70 cannot enter the flushing gas gap 169 counter to the direction of flow of the flushing gas. Obviously, the pressure that acts upon the flushing gas is always to be chosen to be higher than the pressure in the catchment disk region 70.

Thus, at the end of the flushing gas gap 169 at which the latter terminates in the catchment disk region 70, a sealing surface is produced. Product or suspension cannot enter the flushing gas slot, as a result of which the gas-lubricated sliding ring seal 160 is protected from contamination. In particular, no product or a suspension can enter the sealing surface 168 or the barrier gas space 170. The sealing arrangement described can, of course, also be used with a liquid-lubricated sliding ring seal. It is naturally also possible to convey a flushing liquid through the flushing gas gap 169 instead of a flushing gas. The flushing fluid is fundamentally a fluid that does not react with the suspension which is to be processed.

Owing to the fact that the sliding ring seal 160 is protected from contamination, the catchment disk region 70 or the sealed off region can be cleaned more easily as the geometry produced is easier to clean. Furthermore, during the cleaning steps, flushing fluid can be injected through the inlet 172 into the catchment disk region 70 or the region which is to be sealed off, thus achieving an additional cleaning effect. Moreover, the geometry 167 provided in the environment of the flushing gas gap 169 can force a spraying effect so that the flushing fluid is distributed better throughout the catchment disk region 70.

FIG. 8 shows an embodiment of the sealing arrangement according to the invention which is used to provide a seal between the fill tube and a fluid fill connection 210. A sealing surface 168 is also formed between a rotating sliding ring 162 and a stationary sliding ring 164. A flushing gas gap 169 is formed by a housing element 166, which is also positioned transversely in front of the sealing surface 168. A flushing gas is conveyed out of a flushing gas space 172 through inlets 174 and permanently through the flushing gas column 169 and opens into the fill tube 19. As a result of the sealing arrangement described, a suspension introduced into the fill tube 19 cannot enter the flushing gas gap 169 counter to the direction of flow of the flushing gas and contaminate the sealing arrangement. In this way, this sealing region which is difficult to access is reliably protected from contamination, which makes total cleaning of the centrifuge device substantially easier. As can be seen, the basic principle of this sealing arrangement is the same as in the seal in FIG. 7. Here too, instead of a gas lubricated sliding ring seal, a liquid lubricated sliding ring seal can also be used, of course, just as a flushing liquid can be injected instead of a flushing gas. After a cleaning operation, a flushing fluid can also be injected through the inlet 174 to clean the points where the fill connection 210 is joined to the fill tube 19. This ensures total cleaning of this region and prevents cross-contamination.

The technical features of the invention described hereinbefore allow total and reliable cleaning of the entire centrifuge device without the need to open it or clean it manually. Moreover, the cleaning process can be monitored by cameras and other monitoring means. This ensures that the cross-contamination is totally prevented. A second suspension can be processed immediately after a first suspension, even if the first suspension was toxic or would give rise to undesirable reactions with the second suspension. Because the cleaning operation is also carried out automatically without any manual intervention, the time saving improves the economic viability of the centrifuge device according to the invention.

1. Centrifuge device, comprising:
a drive shaft with a rotational shaft axis,
a drum attached to the drive shaft having a drum jacket and a drum base,
a filter arranged inside the drum and surrounding a working space,
an annular space formed between the filter and drum jacket,
a catchment disk forming an end face of the working space opposite the drum base, the catchment disk and the drum being axially movable relative to one another between a closed position in which the catchment disk seals off the working space and at least one open position,
and a centrifuge housing which surrounds the drum and the filter.

2. Centrifuge device according to claim 1, having an annular channel having an annular channel housing that surrounds the annular channel, adjoining the working space on the catchment disk side.

3. Centrifuge device according to claim 2, having a catchment disk region with a catchment disk housing surrounding the catchment disk region, adjoining the annular channel opposite the working space.

4. Centrifuge device according to claim 1, wherein the filter widens out conically from the drum base to the catchment disk.

5. Centrifuge device according to claim 1, and further comprising a lift adjusting device for pivotably adjusting the centrifuge device about a horizontal axis which forms a substantially right angle with the rotation axis of the drive shaft.

6. Centrifuge device according to claim 5, wherein the lift adjusting device is a trapezium spindle.

7. Centrifuge device according to claim 5, which can be pivoted out of a horizontal position by at least 30 in both directions of rotation.

8. Centrifuge device according to claim 1, wherein at least two axial webs supporting the filter are arranged in the annular space, these webs subdividing the annular space into at least two chambers, and for each of the chambers a drum base opening is provided in the drum base.

9. Centrifuge device according to claim 8, wherein an ultrasound cleaning device is provided inside the centrifuge housing, arranged such that it can be inserted through one of the openings in the drum base into the annular chamber in order to clean the chamber associated with the particular drum base opening.

10. Centrifuge device according to claim 1, wherein the catchment disk is mounted on a hollow catchment disk shaft which forms a PAT channel inside itself, a tube being guided through the PAT channel, projecting into the working space and an ultrasound cleaning device being provided at the end thereof which is in the working space.

11. Centrifuge device according to claim 3, wherein the catchment disk has an encircling collar which is arranged so that in an opened position of the catchment disk the collar together with a catchment disk housing element seals off the catchment disk region from the annular channel.

12. Centrifuge device according to claim 2, wherein at least one follower pin is embedded in the drum, projecting axially into the annular space.

13. Centrifuge device according to claim 2, wherein at least one follower pin is embedded in a pin holding element fixedly attached to the drum, said follower pin projecting axially into the annular space.

14. Centrifuge device according to claim 12, wherein in a housing region that separates the annular channel and the catchment disk region, at least one pin is embedded which is arranged so that it is opposite at least one follower pin.

15. Centrifuge device according to claim 12, wherein at least one recess is provided in the catchment disk which engages with the at least one follower pin or with the at least one pin.

16. Centrifuge device according to claim 1, wherein at least one injection device is arranged in the centrifuge housing in such a way that it sprays a flushing fluid into an intermediate space between the centrifuge housing and drum.

17. Centrifuge device according to claim 16, wherein three injection devices are provided, arranged at 120° intervals around the circumference of the centrifuge housing.

18. Centrifuge device according to claim 2, wherein at least one injection device is arranged in the annular channel housing in such a way as to spray a flushing fluid into the annular channel.

19. Centrifuge device according to claim 18, wherein three injection devices are provided which are arranged at 120° intervals around the circumference of the annular channel housing.

20. Centrifuge device according to claim 3, wherein at least one injection device is arranged in the catchment disk housing in such a way as to spray a flushing fluid into the interior of the catchment disk housing.

21. Centrifuge device according to claim 20, wherein three injection devices are provided which are arranged at 120° intervals around the circumference of the catchment disk housing.

22. Centrifuge device according to claim 3, wherein three injection devices are provided in the centrifuge housing which are arranged at 120° intervals around the circumference of the centrifuge housing and spray a flushing fluid into the intermediate space between the centrifuge housing and drum and wherein, furthermore, three injection devices are provided in the annular channel housing, arranged at 120° intervals around the circumference of the annular channel housing and spraying a flushing fluid into the annular channel, and wherein in the catchment disk housing there are three injection devices which are arranged at 120° intervals around the circumference of the catchment disk housing and spray a flushing fluid into the interior of the catchment disk housing.

23. Centrifuge device according to claim 8, wherein an in particular axially movable nozzle is arranged opposite at least one of the openings in the drum base so that it injects a fluid through the respective opening in the drum base into the corresponding chamber of the annular space.

24. Centrifuge device according to claim 23, wherein at a tip of the at least one nozzle, there is mounted a plate element with a flange for sealing off the at least one nozzle at the drum base.

25. Centrifuge device according to claim 24, wherein the at least one nozzle and the respective plate element are integrally formed.

26. Centrifuge device according to claim 23, wherein a bellows is arranged between the plate element and the centrifuge housing, this bellows surrounding a section of the at least one nozzle located inside the centrifuge housing.

27. Centrifuge device according to claim 23, having a device for causing axial movement of the at least one nozzle.

28. Centrifuge device according to claim 27, wherein the device for effecting axial movement of the at least one nozzle is a reciprocating piston arrangement.

29. Centrifuge device according to claim 27, wherein the device for effecting axial movement of the at least one nozzle is a pneumatic device.

30. Centrifuge device according to claim 23, wherein the nozzle is a Laval nozzle.

31. Centrifuge device according to claim 23, wherein a valve is provided in such a way that a fluid flows through the at least one valve before entering the at least one nozzle.

32. Centrifuge device according to claim 31, wherein the valve is a cone membrane valve.

33. Centrifuge device according to claim 31, wherein separate inlets for a plurality of fluids are provided for the at least one valve.

34. Centrifuge device according to claim 16, wherein a fluid used is air.

35. Centrifuge device according to claim 16, wherein a fluid used is nitrogen.

36. Centrifuge device according to claim 16, wherein a fluid used is steam.

37. Centrifuge device according to claim 16, wherein a fluid used is a suitable solvent for the suspension.

38. Centrifuge device according to claim 1, wherein at least one sliding ring seal gas-lubricated with a barrier gas is provided as the seal on at least one shaft of the centrifuge device, this sliding ring seal comprising a sealing surface arranged between a fixed sliding ring and a rotating sliding ring.

39. Centrifuge device according to claim 38, wherein the sealing surface of the gas-lubricated sliding ring seal extends radially outwards from the at least one shaft.

40. Centrifuge device according to claim 39, wherein a housing portion is arranged such that it is disposed in front of the radially outer limit of the sealing surface of the gas-lubricated sliding ring seal, so that the housing portion defines a flushing gas gap between itself and the sliding ring seal.

41. Centrifuge device according to claim 40, wherein inlets are provided in the centrifuge housing which carry a flushing fluid permanently into an interior of the centrifuge device through the flushing gas slot.

42. Centrifuge device according to claim 41, wherein the pressure acting upon the flushing fluid is less than the pressure acting upon the barrier gas of the sliding ring seal.

43. Centrifuge device according to claim 42, wherein the pressure acting upon the flushing gas is approximately 3 bar and the pressure acting on the barrier gas is approximately 6 bar.

44. Centrifuge device according to claim 38, wherein the sliding ring seal is provided on the drive shaft in order to seal the intermediate space between the centrifuge housing and the drum.

45. Centrifuge device according to claim 38, having an annular channel adjoining the catchment disk on the side of the working space, with an annular channel housing surrounding the annular channel, wherein the sliding ring seal for sealing the annular channel is provided on a catchment disk shaft on which the catchment disk is mounted.

46. Centrifuge device according to claim 38, having an annular channel adjoining the working space on the catchment disk side and a catchment disk region adjoining the annular channel opposite the working space and a catchment disk shaft on which the catchment disk is mounted, wherein the sliding ring seal for sealing the catchment disk region is provided on the catchment disk shaft.

47. Centrifuge device according to claim 38, wherein at least one of the shafts of the centrifuge device is hollow and thus forms a fill channel therein for the introduction of the suspension, and wherein the sliding ring seal is intended for sealing an insertion pin projecting into the fill channel on the corresponding shaft.

48. Method of operating a centrifuge device, comprising the following steps:
a. introducing a suspension into the drum,
b. centrifuging the suspension,
c. carrying out a first cleaning of the annular channel and the interior of the centrifuge housing,
d. drying the suspension,
e. removing the dried product,
f. carrying out a second cleaning of the annular channel and the interior of the centrifuge housing and the centrifuge device as a whole.

49. Method of operating a centrifuge device according to claim 48, wherein the centrifuge device has the features of claim 22 and the cleaning steps are carried out by injecting a suitable flushing fluid through the nozzles, the injection devices and the inlets.

50. Method of operating a centrifuge device according to claim 48, wherein the centrifuge device has the features of claim 14 and before the second cleaning step the catchment disk is moved into a half-open central position in which it engages in the at least one follower pin.

51. Method of operating a centrifuge device according to claim 48, wherein the centrifuge device has the features of claim 23 and the drum rotates continuously during the cleaning steps and the flanges of the plates of the nozzles are moved up to the drum base but do not make contact with it, and wherein, when an opening in the drum base is located opposite the at least one nozzle, a pulse of flushing fluid is sprayed into each opening in the drum base.

52. Method of operating a centrifuge device according to claim 48, wherein the centrifuge device has the features of claim 23 and the drum rotates continuously during the cleaning steps and the flanges of the plates of the nozzles are moved up to the drum base but do not make contact with it, and wherein, when an opening in the drum base is located opposite the at least one nozzle, a pulse of flushing fluid is injected into the opening in the drum base, while between the individual pulses of flushing fluid, at least one opening in the drum base passes the at least one nozzle without a pulse of flushing fluid being injected.

53. Method of operating a centrifuge device according to claim 48, wherein the centrifuge device has the features of claim 23 and during the cleaning steps the injection of flushing fluid is carried out in pulses and the drum is rotated through a certain angle between the pulses, while during the pulses the drum is rotated into a position such that the at least one nozzle is arranged opposite the corresponding opening in the drum base and the flanges abut on the drum base.

54. Method of operating a centrifuge device according to claim 48, wherein the centrifuge device has the features of claim 5 and before the filling step the centrifuge device is tilted by an angle α from the horizontal by means of the lift adjusting device so that the centre point of the drum base is located above the centre point of the catchment disk.

55. Method of operating a centrifuge device according to claim 54, wherein the centrifuge device is tilted by an angle β to the horizontal, between the first cleaning step and the drying step, by means of the lift adjusting device, such that the centre of the catchment disk is located above the centre of the drum base and then, before the drying step, it is tilted by an angle α to the horizontal once more so that the centre of the drum base is located above the centre of the catchment disk.

56. Method of operating a centrifuge device according to claim 48, wherein the centrifuge device has the features of claim 5 and the centrifuge device is tilted by an angle β to the horizontal by means of the lift adjusting device, after the second cleaning step, such that the centre of the catchment disk is located above the centre of the drum base.

57. Method of operating a centrifuge device according to claim 54, wherein both the angle α and the angle β is about 3°.
